(19) United States
(12) Patent Application Publication
(10) Pub. No.: US 2019/0089212 A1
(43) Pub. Date: Mar. 21, 2019

(54) ROTOR WITH NONMAGNETIC INSERT

(71) Applicant: FORD GLOBAL TECHNOLOGIES, LLC, Dearborn, MI (US)

(72) Inventors: Feng LIANG, Troy, MI (US); Lusu GUO, Canton, MI (US); Michael W. DEGNER, Novi, MI (US)

(21) Appl. No.: 15/706,431

(22) Filed: Sep. 15, 2017

(51) Int. Cl. H02K 1/27; F03D 9/25; B60K 6/26; H02K 15/03

(52) U.S. Cl. CPC H02K 1/276; F03D 9/25; H02K 15/165; H02K 15/03; B60L 2240/423; B60K 6/26

(57) ABSTRACT

A motor for a vehicle includes a stator, a rotor disposed within the stator and defining a cavity and retention member protruding into the cavity, a permanent magnet disposed within the cavity, and a nonmagnetic insert disposed between the retention member and an end of the magnet to separate the retention member and magnet to interrupt stator-induced demagnetization of the magnet during operation.

### TECHNICAL FIELD

The present disclosure relates to a nonmagnetic insert for interrupting stator-induced demagnetization of a permanent magnet during rotor operation.

### BACKGROUND

Extended drive range technology for electrified vehicles, such as battery electric vehicles (“BEVs”) and plug in hybrid vehicles (“PHEVs”), is continuously improving. Achieving these increased ranges, however, often requires traction batteries and electric machines to have higher power outputs and operate at increased efficiencies in comparison to previous BEVs and PHEVs.

### SUMMARY

A motor for a vehicle includes a stator, a rotor disposed within the stator and defining a cavity and retention member protruding into the cavity, a permanent magnet disposed within the cavity, and a nonmagnetic insert disposed between the retention member and an end of the magnet to separate the retention member and magnet to interrupt stator-induced demagnetization of the magnet during operation.

A motor for a vehicle includes a stator including a plurality of windings configured to generate a magnetic field from supplied electrical current, a rotor disposed within the stator, the rotor defining a cavity and pair of retention members extending into the cavity, a permanent magnet disposed within the cavity, and a pair of nonmagnetic inserts, each insert disposed between one of opposing ends of the magnet and an adjacent one of the retention members to separate the magnet and respective retention member to interrupt stator-induced demagnetization of the magnet when the stator magnetic field interacts with magnetic field of the rotor to operate the rotor.

A rotor for an electric motor includes a lamination defining a pair of cavities disposed adjacent to one another about respective first ends and extending away from one another about respective second ends opposite the first ends to define a V-shaped configuration, the lamination defining retention members protruding into the cavities about the ends, a pair of permanent magnets, each magnet disposed within one of the cavities, and a pair of nonmagnetic inserts, each insert disposed between and engaging the retention member and magnet to separate the retention member and magnet about a path of reluctance generated during the rotor operation.

### BRIEF DESCRIPTION OF THE DRAWINGS

FIG. 1 is a block diagram illustrating an example electrified vehicle;

FIG. 2 is a perspective view of an example electric machine;

FIG. 3A is a cross-section view of a portion of the electric machine;

FIG. 3B is a perspective view of a permanent magnet;

FIGS. 4A-4B are detailed views, in cross-section, of a portion of the electric machine;

FIGS. 5A-5B are detailed views of a nonmagnetic insert of the electric machine;

FIGS. 6A-6B are detailed views of hollow nonmagnetic inserts;

FIGS. 7A-7B are detailed views of laminations including multiple layers of permanent magnets engaging nonmagnetic inserts; and

FIGS. 8A-8C are detailed views of laminations including permanent magnets, with each magnet engaging a plurality of nonmagnetic inserts.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Electric machines of a hybrid electric vehicle may include a stator defining a cavity sized to receive a rotor therein. Excitation of coil windings of the stator by electric current may generate a magnetic field that interacts with a magnetic field generated by permanent magnets of the rotor, thereby causing rotational displacement of the rotor with respect to the stator. When subjected to external magnetic fields, including field generated by the windings of the stator, and/or temperature changes, the magnetic properties of permanent magnets may change, leading to demagnetization, which may affect the performance of the electric machine. As one example, demagnetization may decrease an efficiency of the motor and result in unbalanced magnetic pull that, in turn, causes vibration and a rise in noise.

One or more corners of the magnets may be especially vulnerable to demagnetization as the magnet stops create an easy path for the demagnetization field. As one example, increasing magnet thickness may help reduce or eliminate the demagnetization. As another example, a nonmagnetic insert disposed between a body of the magnet and magnet stops may increase an ability of the magnet to minimize effects of the demagnetization field generated during rotor operation.

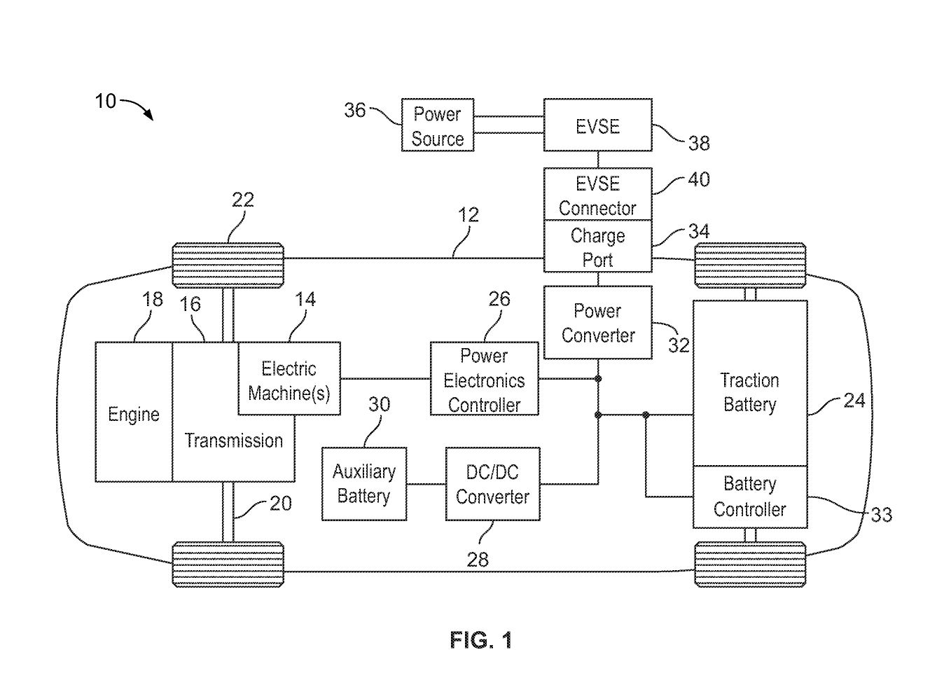

FIG. 1 depicts a block diagram 10 illustrating a vehicle 12 comprising one or more electric machines 14 mechanically connected to a hybrid transmission 16. The electric machines 14 may be capable of operating as a motor or a generator. In addition, the hybrid transmission 16 may be mechanically connected to an engine 18. The hybrid transmission 16 may also be mechanically connected to a drive shaft 20 that is mechanically connected to the wheels 22. The electric machines 14 can provide propulsion and deceleration capability when the engine 18 is turned on or off. The electric machines 14 may also act as generators and may provide fuel economy benefits by recovering energy that would normally be lost as heat in the friction braking system. The electric machines 14 may also provide reduced pollutant emissions since the hybrid-electric vehicle 12 may be operated in electric mode or hybrid mode under certain conditions to reduce overall fuel consumption of the vehicle 12.

A traction battery (or battery pack) 24 stores and provides energy that may be used by the electric machines 14. The traction battery 24 may provide a high voltage DC output from one or more battery cell arrays, sometimes referred to as battery cell stacks, within the traction battery 24. The battery cell arrays may include one or more battery cells. The traction battery 24 may be electrically connected to one or more power electronics controllers 26 through one or more contactors (not shown). The one or more contactors isolate the traction battery 24 from other components when opened and connect the traction battery 24 to other components when closed.

The power electronics controller 26 may also be electrically connected to the electric machines 14 and may be configured to bi-directionally transfer electrical energy between the traction battery 24 and the electric machines 14. For example, the traction battery 24 may provide a DC voltage while the electric machines 14 may require a three-phase AC voltage to function. The power electronics controller 26 may convert the DC voltage to a three-phase AC voltage as required by the electric machines 14. In a regenerative mode, the power electronics controller 26 may convert the three-phase AC voltage from the electric machines 14 acting as generators to the DC voltage required by the traction battery 24. Portions of the description herein are equally applicable to a pure electric vehicle. For a pure electric vehicle, the hybrid transmission 16 may be a gear box connected to an electric machine 14 and the engine 18 may not be present.

In addition to providing energy for propulsion, the traction battery 24 may provide energy for other vehicle electrical systems. A DC/DC converter 28 may convert high voltage DC output of the traction battery 24 to a low voltage DC supply that is compatible with other vehicle loads. Other high-voltage loads, such as compressors and electric heaters, may be connected directly to the high-voltage without the use of the DC/DC converter 28. The low-voltage systems may be electrically connected to an auxiliary battery 30 (e.g., 12V battery).

A battery controller 33 may be in communication with the traction battery 24. The battery controller 33 may be configured to monitor and manage operation of the traction battery 24, such as via an electronic monitoring system (not shown) that manages temperature and charge state of each of the battery cells.

The vehicle 12 may be, for example, an electrified vehicle that includes components for a plug-in hybrid electric vehicle (PHEV), a full hybrid electric vehicle (FHEV), a mild hybrid electric vehicle (MHEV), or a battery electric vehicle (BEV). The traction battery 24 may be recharged by an external power source 36. The external power source 36 may be a connection to an electrical outlet. The external power source 36 may be electrically connected to electric vehicle supply equipment (EVSE) 38. The EVSE 38 may provide circuitry and controls to regulate and manage the transfer of electrical energy between the power source 36 and the vehicle 12. The external power source 36 may provide DC or AC electric power to the EVSE 38.

The EVSE 38 may have a charge connector 40 for plugging into a charge port 34 of the vehicle 12. The charge port 34 may be any type of port configured to transfer power from the EVSE 38 to the vehicle 12. The charge port 34 may be electrically connected to a charger or on-board power converter 32. The power converter 32 may condition the power supplied from the EVSE 38 to provide the proper voltage and current levels to the traction battery 24. The power converter 32 may interface with the EVSE 38 to coordinate the delivery of power to the vehicle 12. The EVSE connector 40 may have pins that mate with corresponding recesses of the charge port 34.

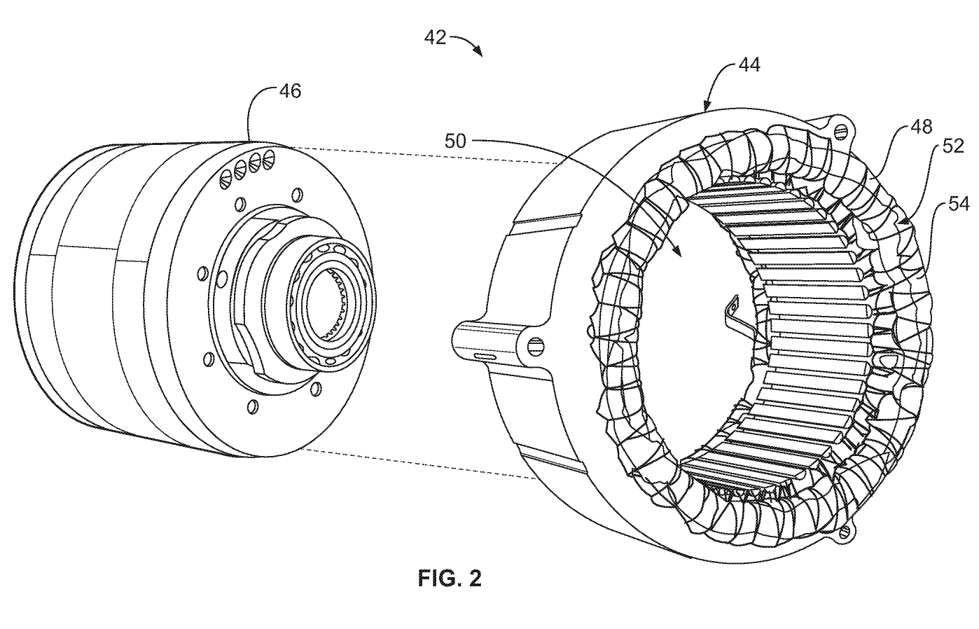

FIG. 2 shows an example electric machine for an electrified vehicle, referred to generally as an electric machine 42 herein. The electric machine 42 may include a stator 44 and a rotor 46. In some examples, electrified vehicles may include two electric machines. One of the electric machines may function primarily as a motor and the other may function primarily as a generator. The motor may operate to convert electricity to mechanical power and the generator may operate to convert mechanical power to electricity.

In one example, the stator 44 may define a cavity 50. The rotor 46 may be sized for disposal and operation within the cavity 50. A shaft (not shown) operably connected to the rotor 46 may drive rotation thereof and/or transfer rotational energy generated by operation of the rotor 46 to one or more subsystems of the vehicle 12. The stator 44 may include windings 48 disposed about an outer periphery of the cavity 50 to surround outer surface of the rotor 46. In an electric machine motor example, current may be fed to the windings 48 to cause the rotor 46 to rotate. In an electric machine generator example, current generated in the windings 48 by rotation of the rotor 46 may be removed to power vehicle 12 components.

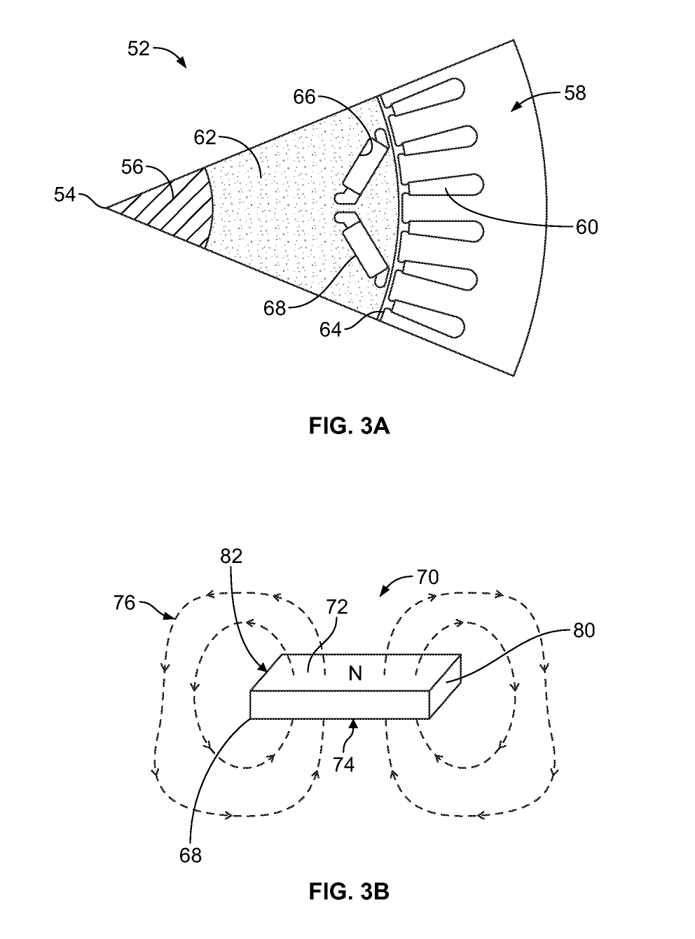

In some examples, the rotor 46 and the stator 44 may comprise one or more ferrous laminations. FIG. 3A illustrates a partial radial cross-sectional view 56 including a stator lamination portion (hereinafter, stator lamination) 58 and a rotor lamination portion (hereinafter, rotor lamination) 62. The laminations 58, 62 may define an air gap 64 between inner periphery of the stator lamination 58 and outer periphery of the rotor lamination 62. In some instances, the laminations 58, 62 may be arranged in a stacked manner and be further interlocked or loose with respect to one another.

The stator lamination 58 may define a plurality of openings 60 radially extending from the inner periphery of the stator lamination 58 and sized to house or retain coil windings, e.g., the windings 48. The rotor lamination 62 may define a plurality of permanent magnet openings (cavities) 66 disposed near the outer periphery of the rotor lamination 62 and each cavity 66 sized to receive a permanent magnet 68. It should be appreciated that the magnets 68 and the cavities 66 may include corresponding cross sectional shapes perpendicular to the axis of rotation 54, such as the rectangular shapes shown, or alternatively arcuate shapes. The rotor lamination 62 may further define a circular central opening for receiving a driveshaft 56, as well as, one or more openings (not shown) configured to accommodate flow of cooling oil through the rotor 46.

FIG. 3B illustrates a perspective view 70 of an example magnet 68. Each magnet 68 may be generally rectangular in cross-section, e.g., comprising four sidewalls joined together about respective ends to form an enclosure and further interconnected via top and bottom portions. As an example, a first end 72 of the magnet 68 may define a north pole and a second end 74 opposite the first end 72 may define a south pole. As another example, lines 76 may illustrate magnetic flux flow from the north pole to the south pole. The permanent magnets 68 may include any type of magnetic or nonmagnetic material or a combination thereof, suitable for use in the electric machine 14. For example, each of the plurality of permanent magnets 68 may include one or more of a ferrite magnet, an Alnico magnet, a rare-earth magnet, such as, but not limited to, Neodymium iron boron (NedFeB), and so on.

The magnets 68 may be disposed end-to-end in the magnet cavities 66 with the end 80 of one magnet 68 abutting the end 82 of the adjacent magnet 68. The cavities 66 may include cutouts, slots, through openings, and so on. The windings 48 of the stator 44 may magnetically interact with the permanent magnets 68 disposed within the cavities 66 of the rotor 46 to generate torque to generate rotation of the rotor 46 about the axis of rotation 54 relative to the stator 44.

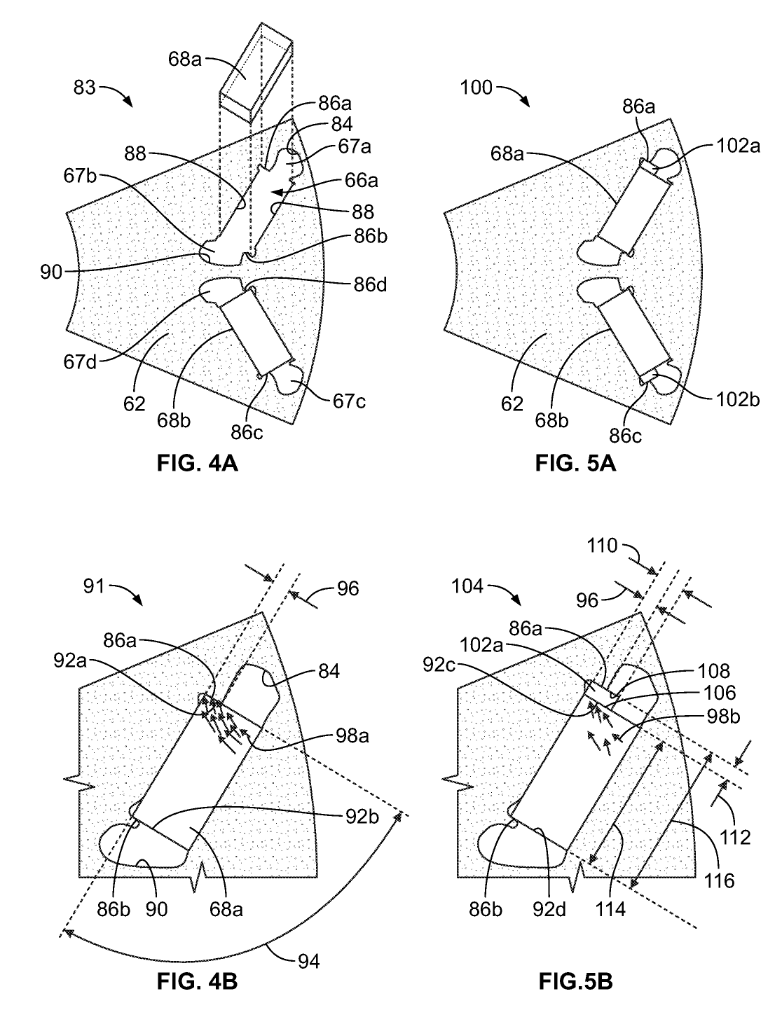

FIG. 4A illustrates an example layout 83 of a pair of embedded permanent magnets 68 within the rotor lamination 62. The rotor lamination 62 may include a plurality of inner walls that define a plurality of permanent magnet cavities 66. For example, a first inner wall 78, a second inner wall 84, a third inner wall 88, and a fourth inner wall 90 define a first permanent magnet cavity (hereinafter, first cavity) 66a of the plurality of permanent magnet cavities 66. In the exemplary embodiment, the rotor lamination 62 may further include inner walls that define a second permanent magnet cavity (hereinafter, second cavity) 66b. The cavities 66a-b may be generally rectangular openings. Additionally or alternatively, the cavities 66a-b may be of any suitable shape consistent with housing the permanent magnet 68 to operate the rotor 46.

A first permanent magnet 68a may be disposed within the first cavity 66a and a second magnet 68b may be disposed within the second cavity 66b. The magnet 68 disposed within the cavity 66 may define one or more air pockets (or air gaps) 67 about opposing ends of the magnet 68. The plurality of pockets 67 of a given cavity 66 may be same or different in magnitude and shape from that of one another and the plurality of pockets 67 of a given rotor lamination 62 may, likewise, be the same or may differ in their respective measured capacity and spatial dimensions.

In some examples, the rotor 46 may define a plurality of rotor poles, e.g., ten rotor poles, with each rotor 46 pole including two permanent magnets 68. For example, the first magnet 68a and the second magnet 68b may define a first rotor pole. Likewise, two additional permanent magnets (not shown) embedded within the rotor 46 may define a second rotor pole, and so on. In some examples, the rotor 46 may include any number of poles consistent with desired operating parameter values of the electric machine 14. Additionally or alternatively, each of the plurality of rotor 46 poles may be defined by more or fewer embedded permanent magnets 68, such as, but not limited to, by one permanent magnet, three permanent magnets, four permanent magnets, or another number of permanent magnets consistent with desired operating parameter values of the electric machine 14.

The rotor lamination 62 may define a plurality of retention members, e.g., magnetic stops, 86 configured to secure the magnet 68 within the corresponding cavity 66. As one example, the rotor lamination 62 may define a first pair of retention members 86a, 86b protruding (or extending) into the first cavity 66a and a second pair of retention members 86c, 86d protruding into the second cavity 66b. The retention members 86 may be protrusions that extend substantially radially from one of the inner walls of the lamination 62. In some examples, the retention members 86 may also be referred to as protruding members and/or tabs. While the example layout 83 illustrated in FIG. 4A includes the retention members 86a-d, other layouts 83 that include more or fewer retention members 86 protruding into each of the magnet cavities 66 and/or protruding into the magnet cavities 66 from same or different inner walls of the rotor lamination 62 are also contemplated.

The retention members 86 may be configured to bias the permanent magnet 68 toward the inner wall of the lamination 62 to maintain a position of the magnet 68 within the cavity 66 during the rotor 46 operation. FIG. 4B illustrates an example layout 91 of the permanent magnet 68a within the rotor lamination 62. In one example, the retention member 86a may engage at least a portion of a first edge 92a of the magnet 68a and may be configured to bias the magnet 68a toward the fourth inner wall 90 of the cavity 66a. Additionally or alternatively, the retention member 86b may engage at least a portion of a second edge 92b of the magnet 68a and may be configured to bias the magnet 68a toward the second inner wall 84 of the cavity 66a.

The retention members 86a-b may extend from the first inner wall 78 such that respective angles 94a-b between the corresponding retention member 86 and the first inner wall 78 is less a predefined threshold. Respective widths 96 of each of the retention members 86a-b (i.e., a distance the corresponding retention member 86 extends into the cavity 66a) may be determined such that the retention members 86a-b extend to engage a predefined portion of the first edge 92a and the second edge 92b of the permanent magnet 68a, respectively. It is contemplated that the angles 94a and 94b may be different or same. It is, likewise, contemplated that the corresponding widths 96 may have a same or different magnitude from that of one another. Moreover, one or more retention members 86 of a given rotor lamination 62 may each comprise additional structural, spatial, dimensional, or geometric features, e.g., thickness, width, tilt with respect to one or several inner walls, and so on, that may be same or different from those of one another.

During operation of the rotor 46 with respect to the stator 44, magnetic flux flow 98a may be generated by the windings 48 of the stator 44 and may be particularly attracted to and/or directed toward one or more of the retention members 86 resulting in a demagnetization of an area of the magnet 68 engaging the retention member 86. As one example, demagnetization may decrease an efficiency of the electric machine 14 and/or result in unbalanced magnetic pull that, in turn, causes vibration and a rise in noise. While the magnetic flux flow is generally indicated using arrows 98, the magnetic flux flow having magnitude and direction different from those of the magnetic flux flow 98 is also contemplated.

FIG. 5A illustrates an example layout 100 of a pair of embedded permanent magnets 68c-d within the rotor lamination 62. The rotor lamination 62 may include a plurality of inner walls, e.g., the first, second, third, and fourth inner walls 78a-b, 84a-b, 88a-b, 90a-b, respectively, that define a pair of permanent magnet cavities 66a-b. Each of the cavities 66a-b may be sized to receive one of the permanent magnets 68c-d, each magnet 68 being substantially rectangular in cross-section and defining a pair of opposing edges 92.

A plurality of retention members 86a-d extending into one or both cavities 66a-b from one or more inner walls of the cavity 66 may be configured to fix a position of the magnets 68c-d disposed therein, such that the position of the magnets 68c-d does not change during the rotor 46 operation. In one example, at least one of the retention members 86a-d in each of the cavities 66a-b may engage at least one of the opposing edges 92c-d of the magnet 68c and may be configured to bias the magnet 68c toward the opposing inner wall of the cavity 66a.

As described in reference to at least FIGS. 4A-4B, the pairs of retention members 86 may protrude (or extend) into the cavities 66 from one of the inner walls of the lamination 62 in a substantially radial manner. Moreover, the layout 100 may include more or fewer retention members 86 protruding into each of the magnet cavities 66 and/or the retention members 86 protruding into the magnet cavities 66 from same or different inner walls of the rotor lamination 62.

The layout 100 may include a plurality of nonmagnetic inserts 102, e.g., inserts 102a-b, each insert 102a configured to engage both: (i) at least a portion of the magnet 68 and (ii) the retention member 86 to separate the magnet 68 and the retention member 86. In one example, the nonmagnetic insert 102a disposed between the magnet 68c and the retention member 86a may be configured to bias the magnet 68c toward the inner wall of the cavity 66a opposite the inner wall from which the retention member 86a extends. Thus, the nonmagnetic insert 102a disposed between the magnet 68c and the retention member 86a that extends from the second inner wall 84a may bias the magnet 68c toward the fourth inner wall 90a, and so on.

The nonmagnetic insert 102 may cause magnetic flux flow 98 generated during operation of the rotor 46 with respect to the stator 44 to decrease and/or be eliminated prior to reaching that retention member 86. As one example, the insert 102 may cause an amount of magnetic flux flow 98 attracted to and/or directed toward a given retention member 86 to decrease or wholly dissipate prior to reaching that retention member 86, such that a difference between generated magnetic flux flow 98 and magnetic flux flow 98 measured at the retention member 86a is greater than a predefined threshold.

FIG. 5B illustrates an example layout 104 of the permanent magnet 68c within the rotor lamination 62. A first insert edge 106a of the nonmagnetic insert 102a may engage at least a portion of the magnet 68c and a second insert edge 108a of the nonmagnetic insert 102a may engage at least a portion of the retention member 86a at a same time. The nonmagnetic insert 102a may, thereby, separate the magnet 68c and the retention member 86a and affect an amount of magnetic flux flow 98 generated during the rotor 46 and the stator 44 operation. In one example, the insert 102a may cause a difference between the amount of magnetic flux 98b measured about retention member 86a and the magnetic flux flow 98 generated during the rotor 46 and the stator 44 operation to be greater than a predefined threshold.

In one example, the nonmagnetic insert 102a may be substantially rectangular in cross-section and may comprise one or more nonmagnetic materials, such as, but not limited to, epoxy, glue, and so on. The nonmagnetic insert 102a may define an insert width 110 measured along the first edge 92c of the magnet 68c. The insert width 110, for instance, may be greater than the width 96 of the retention member 86a. Moreover, the insert width 110 of the nonmagnetic insert 102a may be less than width of the magnet 68c, e.g., as defined by length of the first edge 92c.

Additionally or alternatively, the width 110 of the nonmagnetic insert 102a may be determined with respect to one or both of the second edge 92d of the magnet 68c and the retention member 86b. In one example, the retention member 86b extending into the cavity 66a may engage at least a portion of a second edge 92d of the magnet 68c and may bias the magnet 68c toward the inner wall disposed opposite of the inner wall from which it extends, e.g., bias the magnet 68c toward the second inner wall 84a of the cavity 66a. The width 110 of the nonmagnetic insert 102a may, thereby, be determined according to one or both of the width 96 of the retention member 86b and width of the magnet 68c, e.g., as defined by length of the second edge 92d. It is, likewise, contemplated that the respective widths 96 of each of the retention members 86a, 86b may have a same or different magnitude from that of one another.

The nonmagnetic inset 102a may define an insert length 112 measured with respect to one or both of length 114 of the magnet 68c, e.g., as measured between the edges 92c and 92d of the magnet 68c, and a distance 116 between the retention members 86a and 86b. Moreover, the insert length 112 may be measured with respect to one or more other structural, spatial, dimensional, or geometric features of the retention members 86a-b of a given rotor lamination 62, such as, but not limited to, thickness, width, tilt with respect to one or several inner walls, and so on, that may be same or different from those of one another.

It is further contemplated, that cross-sectional shape and/or dimensions of the nonmagnetic insert 102a, such as, but not limited to, width 110, length 112, and so on, may be defined according to the magnetic flux flow 98b measured about the retention member 86a when the insert 102a separates the magnet 68c and the retention member 86a during the rotor 46 operation. Additionally or alternatively, cross-sectional shape and/or dimensions of the nonmagnetic insert 102a may be defined such that a difference between the magnetic flux flow 98b measured about the retention member 86a and the magnetic flux flow 98 generated during the rotor 46 and the stator 44 operation is greater than a predefined threshold.

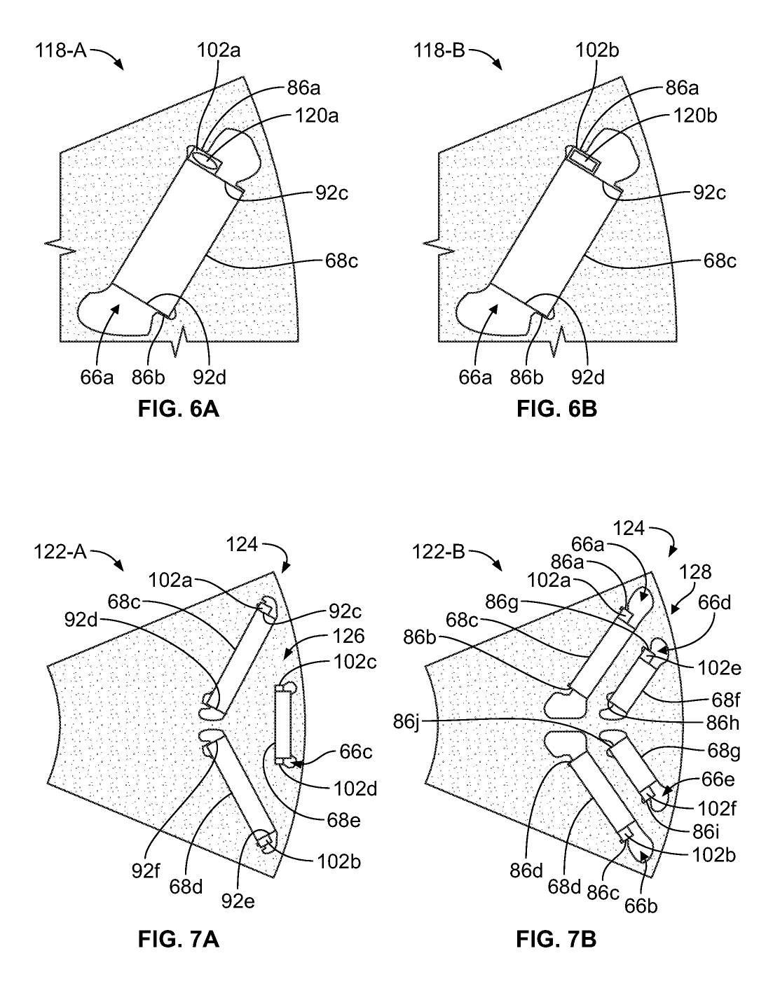

FIGS. 6A-6B illustrate example layouts 118-A and 118-B, respectively, each layout 118 including the permanent magnet 68c disposed within the cavity 66a and the nonmagnetic insert 102c disposed therebetween. In some examples, the nonmagnetic insert 102c may be substantially hollow. For instance, the nonmagnetic insert 102c may define one or more cavities (or voids) 120 therein, such as a substantially oval void 120a, as illustrated in FIG. 6A, or a substantially rectangular void 120b, as illustrated in FIG. 6B. It is contemplated that cross-sectional shape, dimensions and proportional size of the voids 120 may be determined with respect to dimensions and proportional size of the nonmagnetic insert 102c, as described at least in reference to FIGS. 5A-5B. Additionally or alternatively, cross-sectional shape, dimensions and proportional size of the voids 120 may be determined such that difference between generated magnetic flux flow and measured magnetic flux flow is greater than a predefined threshold.

FIG. 7A illustrates an example layout 122-A for the rotor lamination 62 defining a plurality of cavities 66a-c. The cavities 66a-c may be arranged in a plurality of layers 124, 126 with respect to one another and may each be sized to receive one of the permanent magnets 68c-e therein. In one example, the layer 124 may include cavities 66a-b and the permanent magnets 68c-d disposed therein, respectively. The cavities 66a-b of the layer 124 may be arranged substantially in a V-shaped configuration forming an arcuate path, e.g., extending convexly outward toward outer periphery of the rotor lamination 62, such that the magnets 68c-d may be disposed end-to-end. The nonmagnetic inserts 102a-b disposed between the retention members 86a, 86c and the magnets 68a-b may be configured to interrupt stator-induced demagnetization of the magnets 68a-b during operation of one or both of the rotor 46 and the stator 44.

In another example, the layer 126 may include the cavity 66c shaped to define a cross-section perpendicular to the axis of rotation 54 and forming a straight path. The cavity 66c may be sized to receive the permanent magnet 68e having a pair of opposing edges 92e-f. The layer 126 may include a pair of nonmagnetic inserts 102c-d, each insert disposed between one of the retention members 86e-f extending into the cavity 66c and the edge 92e-f of the magnet 68e adjacent thereto.

FIG. 7B illustrates an example layout 122-B for the rotor lamination 62 defining a plurality of cavities 66a, 66b, 66d, 66e. The cavities 66a, 66b, 66d, 66e may be arranged in two layers 124, 128, wherein the layer 124 is a radially inner layer and the layer 128 is a radially outer layer. The layers 124, 128 may be shaped to define an arcuate path oriented convexly outward away from the axis of rotation 54. In some examples, the layer 124 may include the cavities 66a, 66b sized to receive the magnets 68c, 68d, respectively, and the layer 128 may include the cavities 66d, 66e sized to receive magnets 68f, 66g, respectively.

Retention members 86g, 86h may extend into the cavity 66d from one of inner walls defining the cavity 66d and retention members 86i, 86j may extend into the cavity 66e from one of inner walls defining the cavity 66e. Nonmagnetic insert 102e may be disposed between the retention member 86g extending in the cavity 66d and the radially outermost end of the magnet 68f Nonmagnetic insert 102f may be disposed between the retention member 86i extending into the cavity 66e and the radially outermost end of the magnet 68g. The inserts 102e, 102f may separate the end of the magnet 68 and the retention member 86 and may cause magnetic flux 98 generated during the operation of the rotor 46 and stator 44 to decrease prior to reaching the respective retention member 86. In some examples, the radially outermost end of the magnet 68 may be defined relative to the axis of rotation 54, such that the outermost end of the magnet 68 may be an end of the magnet 68 that is located farthest from the axis of rotation 54.

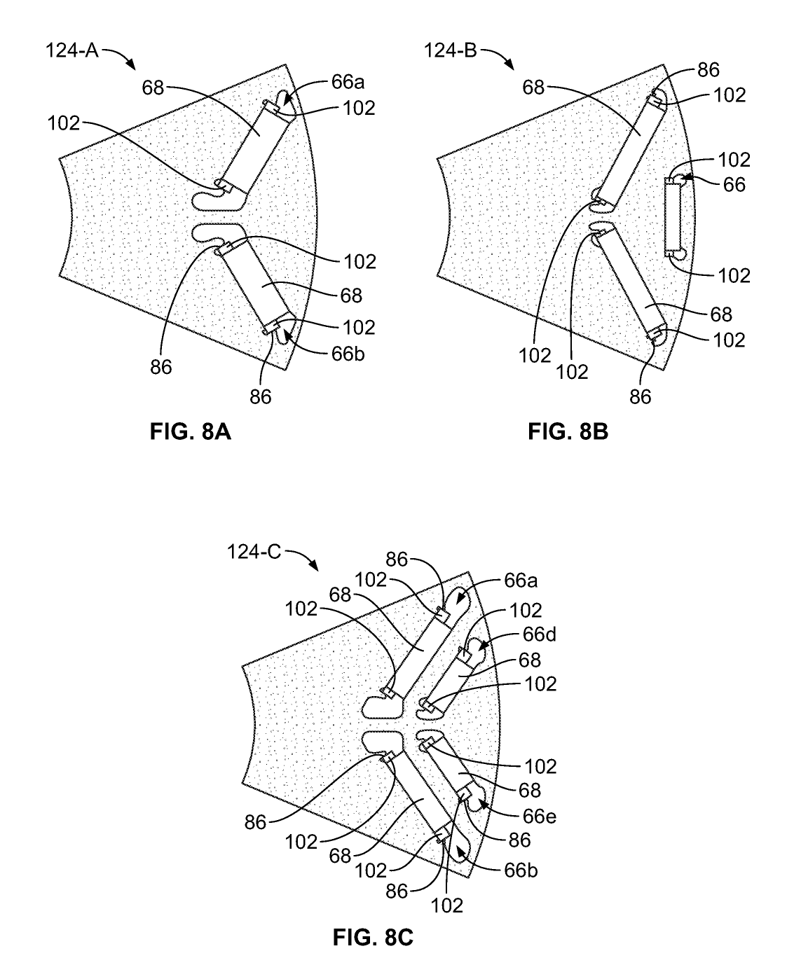

FIGS. 8A-8C illustrate example layouts 124-A, 124-B, and 124-C, respectively, for rotor laminations 62, each rotor lamination 62 defining a plurality of cavities 66. The cavities 66 may be arranged in one of arcuate and straight paths about an outer periphery of the rotor lamination 62 and may be sized to receive a permanent magnet 68 therein. As illustrated in FIGS. 8B-8C, the cavities 66 may be arranged in a plurality of layers, each layer being arranged relative one another with respect to the axis of rotation 54. A pair of nonmagnetic inserts 102 may be disposed between each of distal ends of the magnets 68 and the retention member 86 adjacent thereto to separate the magnet 68 and the retention member 86. In some examples, one or more nonmagnetic inserts 102 may be glued to edge 92 of the magnet 68 to interrupt movement of the insert 102 and the magnet 68 with respect to one another. Furthermore, cross-sectional shape and/or dimensions of the nonmagnetic insert 102, such as, but not limited to, length, width, thickness, and so on, may be defined according to the magnetic flux flow 98 measured about the retention member 86 when the insert 102 separates the magnet 68 and the retention member 86 during the rotor 46 operation. Additionally or alternatively, cross-sectional shape and/or dimensions of the nonmagnetic insert 102a may be defined such that a difference between (i) the magnetic flux flow 98 generated during the rotor 46 and the stator 44 operation and (ii) the magnetic flux flow 98 measured about the retention member 86 is greater than a predefined threshold.

The words used in the specification are words of description rather than limitation, and it is understood that various changes may be made without departing from the spirit and scope of the disclosure. As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A motor for a vehicle, comprising:
a stator;
a rotor disposed within the stator and defining a cavity and retention member protruding into the cavity;
a permanent magnet disposed within the cavity; and
a nonmagnetic insert disposed between the retention member and an end of the magnet to separate the retention member and magnet to interrupt stator-induced demagnetization of the magnet during operation.

2. The motor of claim 1, wherein the insert is hollow.

3. The motor of claim 1, wherein the insert is epoxy or glue.

4. The motor of claim 1, wherein the end is adjacent to an outer periphery of the rotor.

5. The motor of claim 1, wherein the insert is glued to the magnet.

6. The motor of claim 1, wherein a width of the insert is less than a width of the end.

7. The motor of claim 6, wherein the width of the insert is greater than a width of the retention member.

8. The motor of claim 1 further comprising epoxy material that fills an air gap defined by the insert, the end, and the retention member.

9. A motor for a vehicle, comprising:
a stator including a plurality of windings configured to generate a magnetic field from supplied electrical current;
a rotor disposed within the stator, the rotor defining a cavity and pair of retention members extending into the cavity;
a permanent magnet disposed within the cavity; and
a pair of nonmagnetic inserts, each insert disposed between one of opposing ends of the magnet and an adjacent one of the retention members to separate the magnet and respective retention member to interrupt stator-induced demagnetization of the magnet when the stator magnetic field interacts with a magnetic field of the rotor to operate the rotor.

10. The motor of claim 9, wherein the inserts are hollow.

11. The motor of claim 10, wherein voids of the hollow inserts are rectangular or oval-shaped void.

12. The motor of claim 9, wherein the inserts are epoxy or glue.

13. The motor of claim 9, wherein a width of each of the inserts is less than a width of the corresponding end.

14. The motor of claim 13, wherein the width of each of the inserts is greater than a width of the corresponding retention member.

15. The motor of claim 9, wherein the inserts are glued to the corresponding ends.

16. The motor of claim 9 further comprising epoxy material that fills air gaps defined by the inserts, the ends, and the retention members to seal the cavity.

17. A rotor for an electric motor, comprising:
a lamination defining a pair of cavities disposed adjacent to one another about respective first ends and extending away from one another about respective second ends opposite the first ends to define a V-shaped configuration, the lamination defining retention members protruding into the cavities about the ends;
a pair of permanent magnets, each magnet disposed within one of the cavities; and
a pair of nonmagnetic inserts, each insert disposed between and engaging the retention member and magnet to separate the retention member and magnet about a path of reluctance generated during the rotor operation.

18. The rotor of claim 17, wherein the lamination further defines a third cavity extending in a straight line between the second ends and defines corresponding retention members protruding into the third cavity.

19. The rotor of claim 18 further comprising a third permanent magnet disposed within a third cavity and third and fourth nonmagnetic inserts disposed between the third permanent magnet and one of the corresponding retention members to separate the third permanent magnet and the corresponding retention member about a path of reluctance generated during the rotor operation.

20. The rotor of claim 17, wherein the lamination further defines a second pair of cavities disposed between the first pair of cavities and an outer periphery of the lamination and defining a V-shaped configuration.
